(19) United States
(12) Patent Application Publication
(10) Pub. No.: US 2023/0180728 A1
(43) Pub. Date: Jun. 15, 2023

(54) VARIABLE TENSION FISH HOOK

(71) Applicant: KELLY FREDERICK, Walker, LA (US)

(72) Inventor: KELLY FREDERICK, Walker, LA (US)

(21) Appl. No.: 17/546,766

(22) Filed: Dec. 9, 2021

(51) Int. Cl. A01K 83/02; A01K 83/00

(52) U.S. Cl. CPC A01K 83/02; A01K 83/066

(57) ABSTRACT

An improved apparatus for fishing in the form of a hook with multiple hook points, optional snag guard, auxiliary bait retainer, and an adjustable tension arm employed to provide variable tension between multiple hook points for the purpose of more securely and reliably setting a hook in the mouth of a fish.

### CONTINUATION HISTORY

This application is a continuation-in-part of U.S. patent application Ser. No. 16/751,118, filed on Jan. 23, 2020, which is a continuation-in-part of U.S. patent application Ser. No. 15/155,870, filed on May 16, 2016, which is a continuation-in-part of U.S. patent application Ser. No. 13/219,774, filed on Aug. 29, 2011, all of which are hereby incorporated by reference in their entirety.

### BACKGROUND OF THE INVENTION

The present invention relates to an improved design of a multi-featured fishing hook.

Fishing hooks are available in a multitude of designs and varying hook styles, including single and multiple hooks, shapes, colors and sizes. Traditionally, these hooks all have in common the basic elements of an eyelet for connecting to a fishing line, a shank extending therefrom, and one or more hooks formed at the end, used to both secure bait and capture aquatic prey. With this basic design, a fish striking (or attempting to ingest the bait attached to the hook) will become ensnared by the hook, provided the fisherman is able to set the hook sufficiently once in the fish's mouth. This “setting” of the hook is accomplished by the fisherman detecting the strike by observing the line moving as a result of the fish's contact with the bait and line (in the fish's attempt to consume the bait), or the fisherman may feel the actual tugging on the line through the fishing rod, or both. Once this striking activity is ascertained, the fisherman typically will tug (or “pop”) the line in order to get the hook lodged in the fish's mouth (“setting”), and subsequently ensnare the fish. Once hooked in this manner, it is typically far more difficult for a fish to work its way loose of the fisherman's line.

While the above-described method may provide a user with a way to catch fish, this type of apparatus leaves open the possibility of failure due to several reasons, such as not setting the hook quickly enough and having the target fish consume the bait without the hook, having a fish spit the hook out before it has a chance to be set, tugging too violently on the line and pulling the hook from the fish's mouth before it has a chance to be set, and/or tugging too softly and not having the hook sufficiently set within the fish's mouth. If any of these circumstances, or myriad others, occurs, the fish will not be sufficiently secured to the line, and will typically escape capture.

Clear downsides to the current mode of fishing with a traditional hook therefore exist. Firstly, an easy-to-set solution is not readily available, as the fisherman must keep steady vigil over his line in order to detect any striking activity. Secondly, even while the common method of using a fishing hook may have design variations which help to promote setting of the hook, none offer a solution which automatically helps set the hook once struck by the aquatic prey. Further, additional features which provide for additional bait securing and/or snag protection have not been available with fishing hooks. For those methods employed by others to supply an improved hook design which are currently available, the concept is often overwrought and/or ineffective in its implementation.

The consequence of these issues is the inherent ineffectiveness of the current state of the art for fishing hooks. The absence of a solution which provides an automatic assist with setting a hook in multiple locations in a secure manner, especially one that includes a snag guard to reduce line entanglements and/or a bait securing barb, has yet to be developed. The present invention provides a simple, innovative and effective apparatus for fishing. The present invention of a revised fishing hook is thus a novel, needed and functional answer to the problems in the field relating to an effective fishing hook.

All of these aspects of the current state of fishing hooks lead to an increased need for a revised method of implementation with minimized cost and complexity, all of which the present invention addresses.

### OBJECTS OF THE INVENTION

One object of the invention is to provide a new fishing hook design.

An additional object of this invention is to provide a fishing apparatus with an adjustable tension arm for setting a hook in a fish when fishing.

Another object of this invention is to provide a new apparatus for hooking a fish in multiple places.

Yet another object of this invention is to provide a fishing hook with a snag guard to prevent a fishing hook from getting caught in vegetation and other hazards.

Still another object of this invention is to provide a fishing hook with a barb that aids in securing bait to a fishing hook.

Still another object of this invention is to provide a fishing hook that is durable.

Other objects and advantages of this invention shall become apparent from the ensuing descriptions of the invention.

### SUMMARY OF THE INVENTION

According to the present invention, an apparatus for fishing is provided in the form of a hook is herein disclosed with multiple hook points, an adjustable tension arm, optional snag guard and auxiliary bait retainer.

### BRIEF DESCRIPTION OF THE DRAWINGS

The accompanying drawings and figures illustrate embodiment(s) of this invention. However, it is to be understood that these embodiments are intended to be neither exhaustive, nor limiting of the invention. They are but examples of some of the forms in which the invention may be practiced.

FIG. 1 is a perspective view of the fishing hook.

FIG. 2 is a side view of the fishing hook.

FIG. 3 is a top view of the fishing hook in the unloaded position.

FIG. 4 is a top view of the fishing hook in the loaded (under tension) position.

FIG. 5 is a side view of the fishing hook in a three-hook configuration.

FIG. 6 is a top view of the fishing hook in a three-hook configuration.

FIG. 7 is a side view of the fishing hook in a four-hook configuration.

FIG. 8 is a top view of the fishing hook in a four-hook configuration.

FIG. 9 is a front view of the fishing hook in a two-hook configuration with additional snag guards and bait-retaining barbs.

FIG. 10 is front view of the fishing hook in a four-hook configuration with additional snag guards and bait-retaining barbs.

FIG. 11 is a front view of the fishing hook in a three-hook configuration with additional snag guards and bait-retaining barbs.

### DETAILED DESCRIPTION OF EXEMPLARY EMBODIMENTS

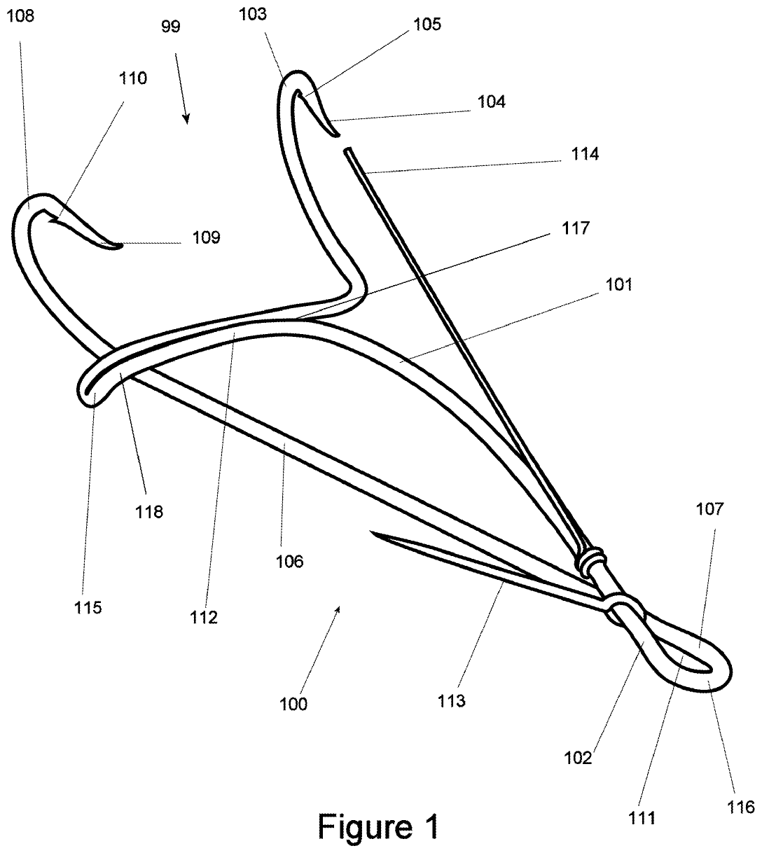

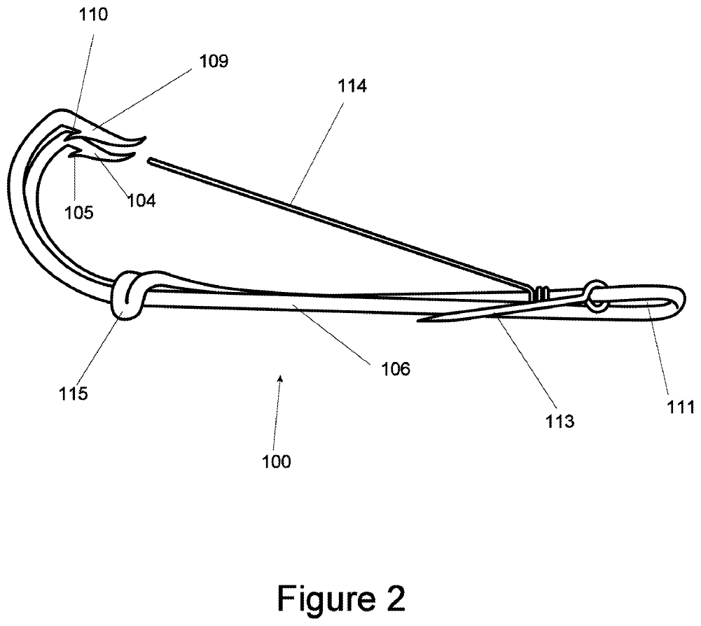

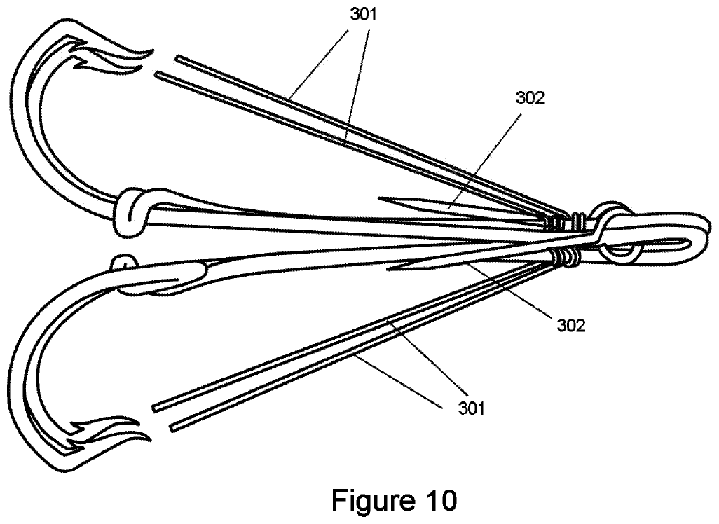

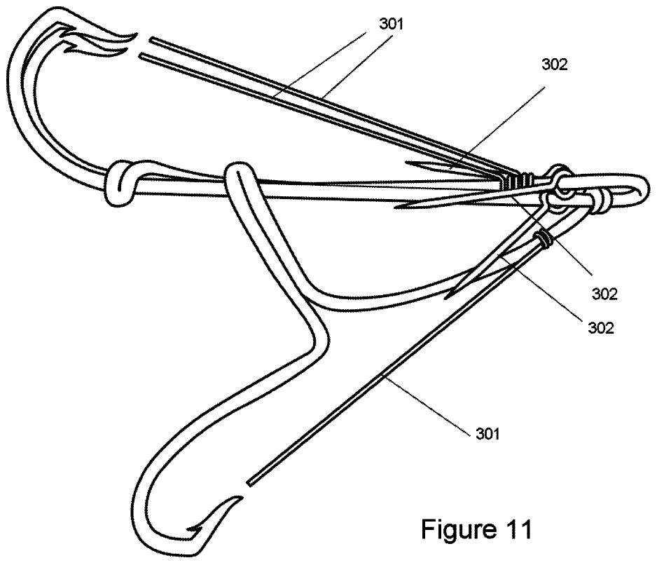

Without any intent to limit the scope of this invention, reference is made to the figures in describing the various embodiments of the invention. FIGS. 1 through 11 depict various aspects of exemplary embodiments of the present invention.

The present invention relates to fishing hook 100 as pictured in FIGS. 1 through 4. Fishing hook 100 is formed by first, or primary shank 101 which has first opposite end 102 and second opposite end 103. Second opposite end 103 is shaped to form a hook 104 and optionally, first barb 105 which can be employed to help retain a fish which may be trapped by fishing hook 100. First barb 105 is a protrusion which is formed by a relief feature along shank 101 with a point, such that the tip of barb 105 can easily pierce an object, but once pierced, a lack of smooth surface prevents barb 105 from being easily backed out. Similarly, fishing hook 100 includes second, or secondary shank 106, which has first opposite end 107 and second opposite end 108 which is also shaped to form a hook 109 and optionally second barb 110.

The two shanks are connected at a common point 116 where first shank's 101 first opposite end 102 is joined to second shank's 106 first opposite end 107. These can, in an exemplary embodiment, be joined to form eyelet 111 through which fishing or other line(s) can be secured to hook 100 and used to tether such a line to hook 100. Common point 116 and resultant eyelet 111 is, in an exemplary embodiment, a single loop (one bend onto itself), not a spring or multiple coil, thus creating a precise level of tension, and resultant subtler release of the hooks, as described elsewhere in the specification. The lack of multiple loops or coils at common point 116 lends itself to a more direct connection from fisherman's line to the hook, which is an advantage. Applicant experimented and discovered that the use of multiple loops, or a spring, had a negative effect on the feel of hook 100 when casting and setting, and so a single loop should be considered part of an exemplary embodiment. This single loop provides an ideal amount of kinetic energy stored in such loop to provide adequate, but not overbearing, unloading of the loop when the hook is released, as well as preventing premature release of the hook when being cast, pulled through water or other manipulations. This single loop also affords the benefit of simplifying construction and use.

Shanks, 101, 106 form hook pair 99. In the exemplary embodiment pictured in the Figures, hook 104, 109 face substantially the same direction, though variations on this are possible and considered within the purview of this invention. In this sense, facing the substantially same directions will be defined as hooks 104, 109, both being on the same side of hook 100, that is, the same vertical plane (when hook is oriented with hooks 104, 109 at the bottom, and common point 116 at the top), and also wherein tips of hooks 104, 109 are pointed in the same direction.

Due to the joining of shanks, 101, 106, at a common point 116, an acute angle is formed between the two shanks, 101, 106. In an exemplary embodiment, this acute angle will fall between the range of 5 to 45 degrees. The precise degree of the angle is dictated by the distance desired between first hook 104 and second hook 109. For example, if a small fish is desired, which has a corresponding small mouth, the distance may be small, which would reduce the angle, and thus the overall width of hook pair 99. A larger mouth opening would dictate a greater distance between the hooks, and thus a larger angle would be present at eyelet 111, and an overall larger width of hook pair 99. Regardless of the size of the desired aquatic prey, angles exceeding this range make the hook too compressed if below 5 degrees, or too large to fit in most desired aquatic prey's mouths if beyond 45 degrees. Thus, this angle becomes a significant feature of hook pair 99. Further, in the exemplary embodiments, first shank 101 and second shank 106 are of a substantially similar length, outside of normal manufacturing tolerances that are relatively insignificant.

Adjustable tension arm 112 is formed along the length of first shank 101, typically by forming a portion of first shank 101 into a new shaft approximately perpendicular to first shank 101 and which is shaped to engage second shank 106 and hold it in tension. Essentially then, along first shank 101, a section is bent perpendicular to itself, and then back again, thus continuing the overall shape of shank 101, but while also introducing the bent, or manipulated section forming tension arm 112 as pictured in the Figures. Tension arm 112 has a proximate end 117 and a distal end 118. The overall length of tension arm 112 will be greater than the distance between first hook 104 and second hook 109 when set to permit an operable connection between the two when set.

In “tension” in this sense means that first shank 101 and second shank 106 are pulled together in closer relation against the forces of the two shanks' 101, 106 common point 116 and retained in place by tension arm interlock 115 located at distal end 118 of tension arm 112.

One exemplary method of this type of arrangement is by having tension arm 112 include a small bend as interlock 115 which is shaped to retain second shank 106 in tension by contacting and retaining second shank 106 at an engagement point which will vary based on hook size, shape, wear and other factors. Interlock 115 will typically be of a length at least twenty percent of said overall length of said tension arm 112 to permit easy manipulation by a user. This minimum length will allow easy manipulation with the fingers of a user, or a tool (such as pliers) if desired. In an exemplary embodiment, the length between proximate end 117 and interlock 115 is at least half that of first shank 101, which allows for a vast amount of variation in the tension by way of having the tension arm be shorter or longer as desired by the user.

The length of tension arm 112 is also, in another exemplary form, of a length of at least half of the overall length of first shank 101, which permits the range of adjustability of tension, as discussed elsewhere in this specification. Tension arm 112 must be of a sufficient length, because should the length of tension arm 112 be less, only a small amount of adjustability, if any, will be permitted, and a shorter tension arm 112 would not allow for easy manipulation solely by the hands of a fisherman. Further, the variable tension aspect of the invention would be lost because tension arm 112 would be too short to permit various and multiple user-selectable points at which to engage first shank 101 to second shank 106. This user-selectable variability is key to the invention, since the adjustment of tension arm 112 is held once set by a user. It is not simply that the tension is variable through the act of setting hook pair 99, but that a multitude of levels of tension are able to be selected and hook pair 99 set to that level. It is the length of tension arm 112 then, that is key to this feature.

Interlock 115, in an exemplary embodiment, is further formed of a curved, or radiused, section of tension arm 112 having a maximum arc of 75-85 degrees, and wherein the arc terminates in a section of interlock 115 beyond the engaged portion of second shank 106 as described above. This gentler arc provides an overlap of interlock 115 beyond second shank 106 without turning back on itself and in turn creating a hook that more firmly binds first shank 101 to second shank 106 which would prevent the decoupling of first shank 101 from second shank 106 without first squeezing the hook together, thus defeating the purpose of the invention. This overlap is included because it allows for a great deal of flexibility and can be critical in determining and/or adjusting the distance between hooks 104, 109 and thus the tension and resultant kinetic energy as described elsewhere in this specification. This extended overlap beyond second shank 106 additionally provides an easy point at which a user can adjust the desired tension, which can readily be manipulated by hand, without the need for tools or advanced dexterity as described elsewhere.

The limitation of arc described further accomplishes two other goals. First, the prevention of fatiguing of the material that interlock 115, and indeed the entire hook 100, is composed of, by preventing a “hard” bend of the material which could result in breakage or reduction in useful life. Bearing in mind that a hard bend has more “memory” in metal than a soft or less than right angle bend, this becomes additionally relevant to extending the life of hook 100, particularly when considering that one of the primary objectives of the invention is to allow variability multiple times of the hook, and it is this gentler arc of the material which allows that durability and flexibility. The second goal addresses the notion that an arc of anything greater, such as 90 degrees, will engage second shank 106 in a more rigid and fast fashion, which may and will prevent the release of second shank 106 at the correct time and in the mode desired to capture a fish. In a practical sense, a fish's strike is largely in one direction, but should interlock 115 require both strike force in one direction and manipulation forward and back to be released from second shank 106, the device would be ineffective for requiring too much manipulation to release hook pair 99. Thus, interlock 115 does not “hook” around second shank 106, locking it in place, but rather partially engages second shank 106 permitting the easier release of the device when in a fish's mouth.

It should be noted that substantially “perpendicular” in the case of the tension arm means perpendicular to the longest dimension of first shank 101 as pictured in FIG. 1. Tension arm 112 will typically be closer to the second opposite end 103 of said first shank 101.

Regarding material construction, in an exemplary embodiment, the entirety of above hook 100 is formed of one continuous piece of material, typically a metal or other durable, ductile and malleable material, for ease of construction and for increased structural integrity. Continuous in this sense means an uninterrupted ductile strand of material, drawn in one piece. In this way, grafting of pieces together, or “connecting” of various components is avoided, adding simplicity and structural rigidity. Having a single extrusion for the hook also reduces failures, decreases the complexities of construction, all of which result in a better product.

An example of this is a malleable and ductile metal such as wire, which can be drawn in a substantially circular cross-section, and from which a single strand of such material the entire hook pair 99 can be formed, by bending or otherwise manipulating the material to form hook pair 99 as described above. Clearly some portions, such as barbs 105, 110, will not be perfectly circular, and the ductile nature of the material may render portions not fully circular, but the substantial portion of hook 100 in the exemplary embodiment will generally be circular in cross-section.

Optionally, fishing hook 100 can also employ snag guard 114. Snag guard 114 is formed of a length of material substantially parallel to shanks 101, 106, affixed and extending substantially from either or both first shank's 101 and second shank's 106 first opposite end 102, 107 toward hooks 104, 109, and terminating near hooks 104, 109. In this way, weeds and other debris are less likely to become tangled in hooks 104, 109 and cause snags, loss of the hook or other detrimental effects. This is accomplished because snag guard 114 discourages the entry of weeds and the like into the plane formed between hooks 104, 109 and first opposite ends 102, 107 thus preventing same from being snared by hooks 104, 109. Snag guard 114 can be employed on any number of hooks, depending on the overall design chosen.

Additionally, fishing hook 100 can include secondary barb 113 on either or both first shank's 101 and second shank's 106 first opposite end 102, 107. Secondary barb(s) 113 extend downward toward hooks 104, 109 such that the points of hooks 104, 109 face the points of secondary barb(s) 113 and are used to help retain bait within fishing hook 100. Secondary barb 113 is constructed of a piece of material attached to shanks 101, 106 and drawn to a point at the end. This additional point assists in capturing and retaining bait and or aquatic prey.

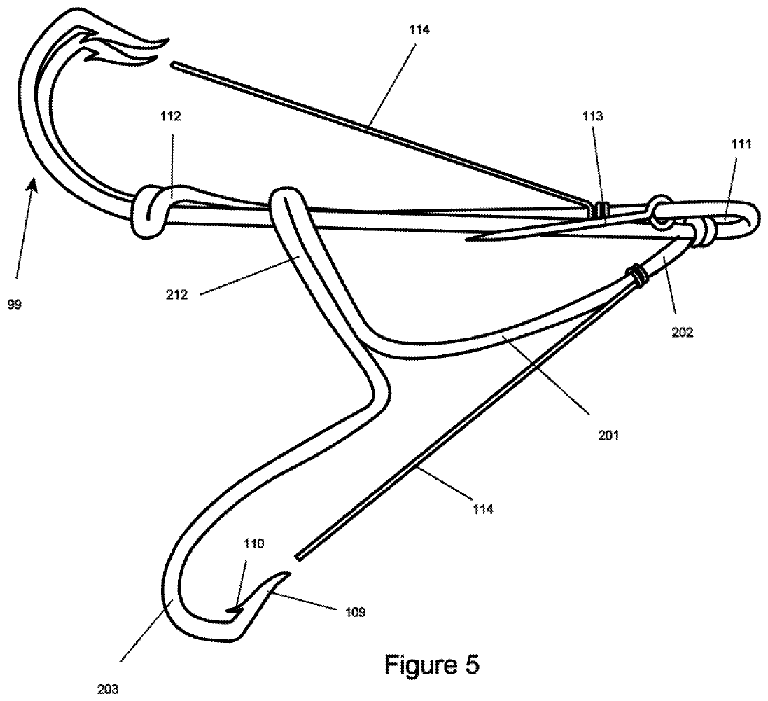

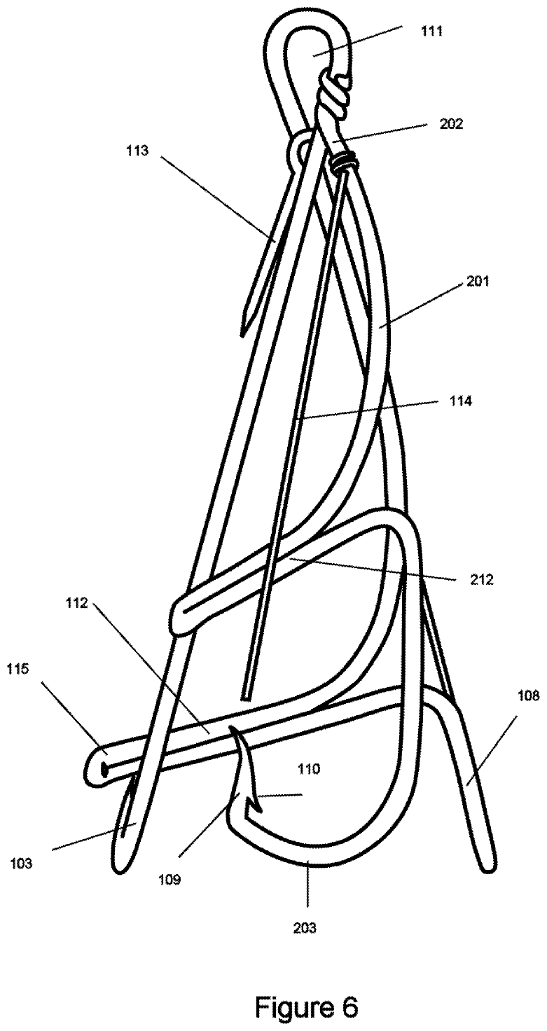

Additional exemplary embodiments are pictured in FIGS. 5-11. FIGS. 5 and 6 show an odd-numbered-hook configuration, in this case, three hooks, wherein hook pair 99 is coupled with at least a third shank 201 having first opposite end 202 and second opposite end 203. Identical in construction to above tension arm 112, tension arm 212 is formed along the length of third shank 201, typically by forming a portion of first shank 201 into a shaft perpendicular to first shank 201 and which, in this iteration, is shaped to engage either first shank 101 or second shank 106 and hold it in tension.

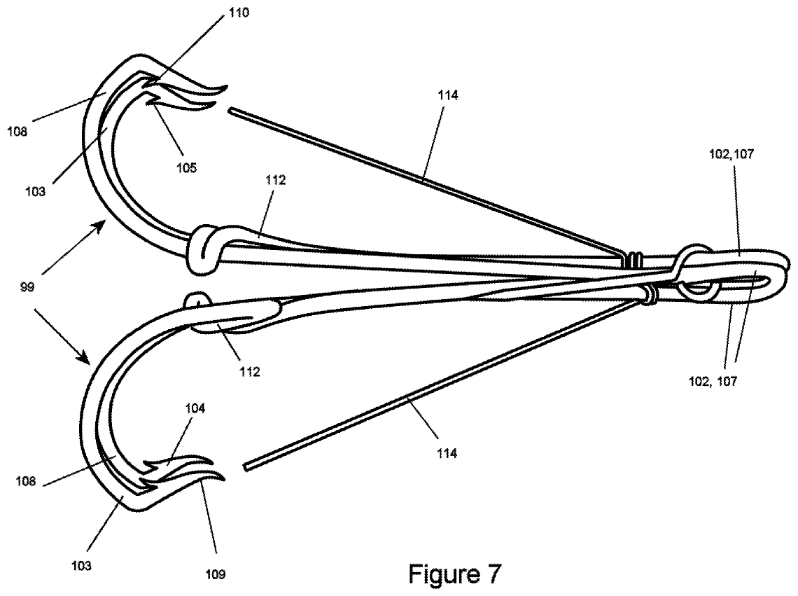

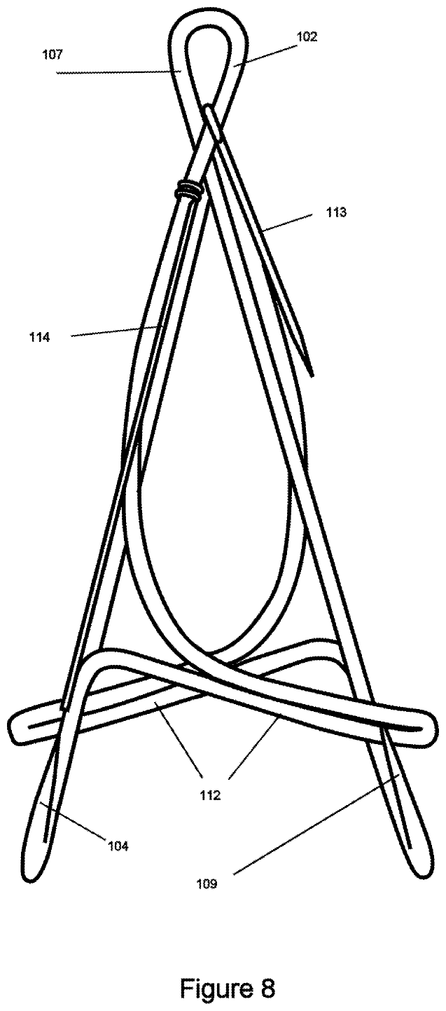

FIGS. 7 and 8 illustrate another exemplary embodiment utilizing a configuration with multiple hook pairs 99. This embodiment adjoins multiple hook pairs 99 together near first opposite ends 102,107 of hook pairs 99, such that many hook pairs 99 can be utilized for capturing aquatic prey.

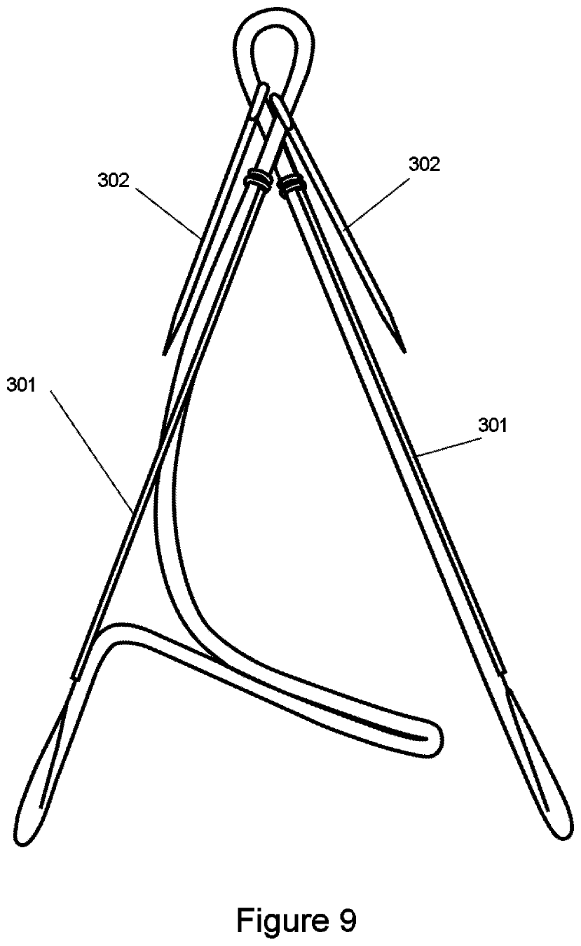

In either of the alternate exemplary embodiments, hooks 104, snag guards, 114, secondary barbs 113, are all employed in the same manner on the additional hook pairs 99 or third shank 201, if desired, as pictured in FIGS. 9-11, by having multiple snag guards 301 and secondary barbs 302.

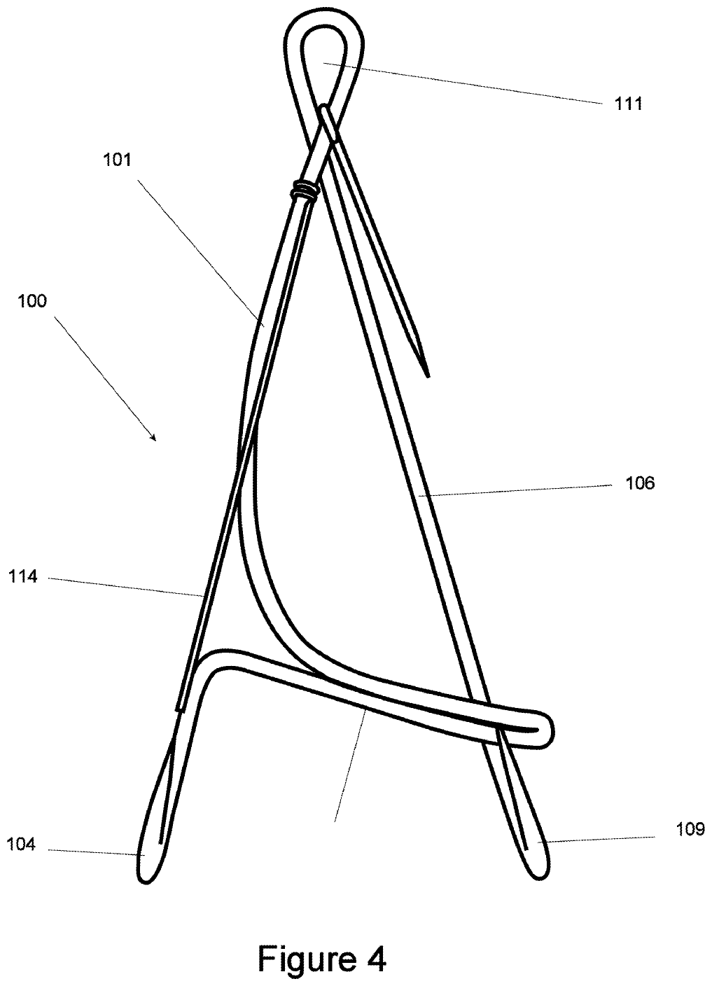

In operation, then, fishing hook 100 is attached to the operator's line of choice via eyelet 111. Tension arm 112 is then “set” by putting tension between first shank 101 and second shank 106 (closing the distance between the two) and then using tension arm 112 on first shank 101 to engage second shank 106 with interlock 115, as seen in FIG. 4 to prevent them from retracting to their original position. In this way, kinetic energy is stored in the common point 116 from shanks 101, 106 exerting forces in opposing directions. Fishing hook 100 can then be baited, on first hook 104 or second hook 109, depending on configuration, and cast in the desired location. If multiple hook pairs 99 are used, each tension arm 112 will be set as desired.

By manipulating interlock 115, bending it by hand or with a tool if desired (enabled because of the malleability mentioned above) the overall length of tension arm 112 in relation to interlock 115 is varied in the “set” position. As tension arm 112 is thusly made shorter, the distance between first hook 104 and second hook 109 is also made smaller, and the opposite forces between first hook 104 and second hook 109 increase as a result, which correlates to an increasing amount of kinetic energy stored in common point 116. Conversely, bending interlock 115 the opposite direction will increase overall length of tension arm 112 and thus the distance between first hook 104 and second hook 109, thereby reducing the tension and stored kinetic energy. This is where the variable tension is manipulated depending on the user's desired tension for a particular application, or the overall width of the “set” hook pair 99.

Due to the extended length of tension arm 112, a great degree of variability in the length of tension arm 112 may be had, and thus a great degree of flexibility in the kinetic energy stored in the “set” hook pair. This significant aspect of the uniqueness of the invention is that the variability can be set by the user to a particular position, multiple times and at various positions until the desired setting is reached. Most existing art has a static-set hook, or the manipulation of the tension would be exceedingly difficult due to the generally small size of the hooks and hook material. The present invention addresses that by utilizing a larger adjustment tension arm 112 which can be readily adjusted with or without the need for tools. The variability of this setting is not just transient during the setting process, (meaning that the kinetic energy stored will be variable as hook pair 99 is being set) but is able to be “set” at several positions, which have significantly disparate effects on the tension being held between first shank 101 and second shank 106, as well as the overall size of hook pair 99, for use in different situations depending on the size of aquatic prey, or fish, desired to be captured.

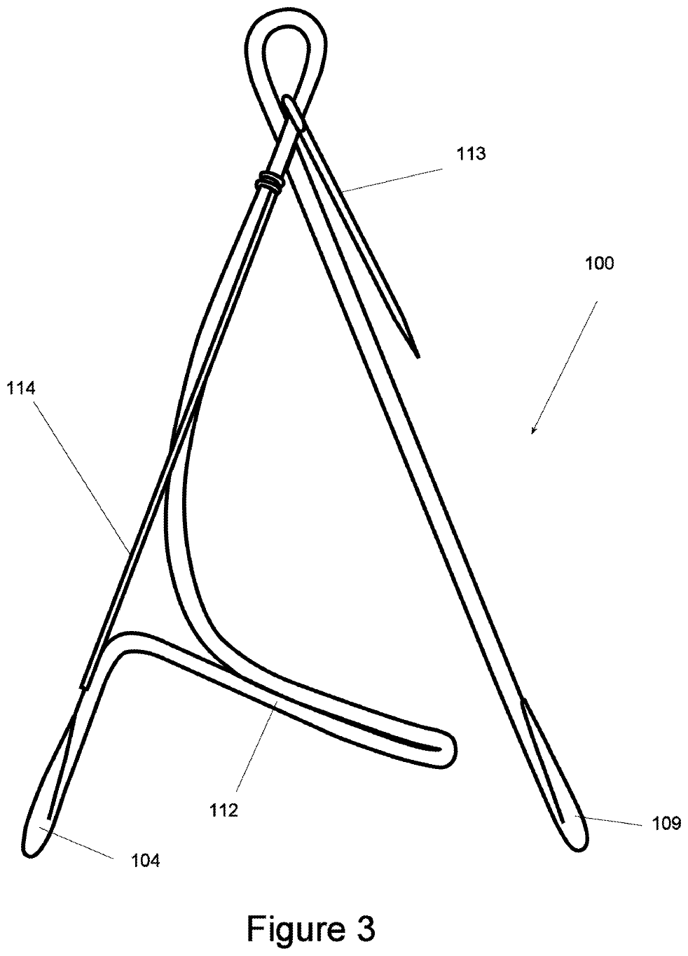

When hook 100 is “hit” or attempted to be ingested by a fish, tension arm 112 will be released by the agitation and turbulent action about hook 100, and will spring open and expend its kinetic energy in the process, as seen in FIG. 3. This widens the spread of hook 100, decreasing the odds that the fish will be able to spit out hook 100. Simultaneously, the splayed hooks 104, 109 are much more likely to snare the fish. Either or both of the above actions ensure a more secured aquatic prey.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A fishing hook comprising at least one hook pair and wherein said at least one hook pair is comprised of:
a. a first shank having first and second opposite ends, wherein said second opposite end is shaped to form a first hook;
b. a second shank having first and second opposite ends, wherein said first shank's first opposite end and said second shank's first opposite end, are operatively attached, and from which both said first shank and said second shank extend outwardly, forming an acute angle therebetween, and wherein said second shank's second opposite end is shaped to form a second hook;
c. an adjustable tension arm formed integrally along said first shank proximate to said second opposite end of said first shank and extending perpendicularly to said first shank, said tension arm having a proximate end and a distal end;
d. an interlock at the distal end of said tension arm which engages said second shank in variable tension with said first shank, and wherein said interlock is formed of a radiused section of said tension arm having a maximum arc of 85 degrees which terminates in a section of said interlock beyond said engaged portion of said second shank; and
e. said adjustable tension arm having a length between said proximate end and said interlock of at least half of a length of said first shank.

2. The fishing hook of claim 1 wherein said operative attachment between said first shank and said second shank is comprised of no more than a single loop.

3. The fishing hook of claim 1 wherein said at least one hook pair is constructed of a single uninterrupted length of durable and ductile material throughout its length.

4. The fishing hook of claim 1 wherein said at least one hook pair has a substantially circular cross-section throughout its length.

5. The fishing hook of claim 1 wherein said acute angle is determined by the distance between said first shank's second opposite end and said second shank's second opposite end, and wherein said distance is variable and adjusted by altering the length of said interlock relative to said tension arm.

6. The fishing hook of claim 5 wherein said acute angle can be varied and set from 5 to 45 degrees by altering the length of said interlock.

7. The fishing hook of claim 5 having a distance between said first shank and said second shank and wherein said tension arm is of a length greater than said distance between said first shank and said second shank when said tension arm is engaged, and wherein at least the last 20% of overall length at the distal end of said tension arm is formed to engage said second shank as said interlock.

8. The fishing hook of claim 1 wherein said first shank's first opposite end and said second shank's first opposite end are operatively attached and form an eyelet comprising a single loop from which both said first shank and said second shank extend outwardly forming said acute angle.

9. The fishing hook of claim 1 wherein at least one of said first and second shanks further comprise barbs formed in said shanks proximate to said hooks.

10. The fishing hook of claim 1 further comprising a snag guard comprising a length of durable material operatively attached to said first shank and extending substantially from said first opposite end of said first shank to said first hook.

11. The fishing hook of claim 1 further comprising a snag guard comprising a length of durable material operatively attached to said second shank and extending substantially from said first opposite end of said second shank to said second hook.

12. The fishing hook of claim 1 further comprising a barb operatively attached to said first shank and extending downward toward said first hook and operatively configured to retain bait in conjunction with said first hook.

13. The fishing hook of claim 1 further comprising a barb operatively attached to said second shank and extending downward toward said second hook and operatively configured to retain bait in conjunction with said second hook.

14. The fishing hook of claim 1 wherein both said second opposite end of said first shank and said second opposite end of said second shank terminate in the same direction, are substantially parallel to one another, and are oriented on the same vertical plane of said fishing hook.

15. The fishing hook of claim 1 wherein said first hook and said second hook are substantially the same length.

16. The fishing hook of claim 2 wherein said loop is further configured to be in increasing tension as said angle is reduced and wherein said loop stores kinetic energy that is disposed to separate said first shank and said second shank and wherein said kinetic energy is directed in opposing directions.

17. A fishing hook comprising at least one hook pair and wherein said at least one hook pair is comprised of a single piece of durable and ductile material having:
a. a first shank having first and second opposite ends, wherein said second opposite end is shaped to form a first hook;
b. a second shank having first and second opposite ends, wherein said second shank's second opposite end is shaped to form a second hook, and wherein said first shank's first opposite end and said second shank's first opposite end are operatively attached with no more than a single loop, and from said single loop both said first shank and said second shank extend outwardly in substantially the same direction, forming an acute angle therebetween;
c. an adjustable tension arm having a proximate end and a distal end formed integrally along said first shank proximate to said second opposite end of said first shank and extending approximately perpendicular to said first shank;
d. an interlock formed by the distal end of said tension arm and shaped to engage said second shank in variable tension with said first shank and wherein said interlock is formed of a radiused section of said tension arm having a maximum arc of 85 degrees which terminates in a section of said interlock beyond said engaged portion of said second shank;
e. wherein said acute angle can be varied and set from 5 degrees to 45 degrees in direct relation to the length of said interlock, thus increasing or decreasing said angle when said interlock is engaged with said second shank;
f. further wherein said adjustable tension arm has a length between said proximate end and said interlock of at least half of the length of said first shank;
g. further wherein said loop is configured to be in inversely proportional tension to said angle and thus stores kinetic energy that is disposed to separate said first shank and said second shank;
h. further wherein both said second opposite end of said first shank and said second opposite end of said second shank terminate in the same direction, are approximately parallel to one another, and are oriented on the same vertical plane; and
i. wherein said interlock is released by a bite force of a live fish, enabling the deployment of said kinetic energy in said loop and causing said first shank and said second shank to energetically separate in substantially opposite directions, thus aiding said hook pair in capturing said live fish by increasing said angle, and therefore width, when in a mouth of said live fish subsequent to the application of said bite force in said mouth of said live fish.
